(19) United States
(12) Patent Application Publication
(10) Pub. No.: US 2019/0085113 A1
(43) Pub. Date: Mar. 21, 2019

(54) LOW-VISCOSITY POLYMERIZABLE PRECURSOR COMPOSITION FOR IMPACT-REINFORCED MATERIALS

(71) Applicant: Arkema France, Colombes (FR)

(72) Inventors: Raber INOUBLI, Villeurbanne (FR); Sylvain BOURRIGAUD, Morlanne (FR); Cathy REY, Labatut (FR); Charles BOURROUSSE, Paris (FR)

(73) Assignee: Arkema France, Colombes (FR)

(21) Appl. No.: 16/078,981

(22) PCT Filed: Feb. 23, 2017
(86) PCT No.: PCT/FR2017/050398

§ 371 Date: Aug. 22, 2018

(30) Foreign Application Priority Data
Feb. 24, 2016 (FR) 1651491

(51) Int. Cl. C08F 290/04; C09D 4/00; C09D 153/00; C09D 11/101; C09D 11/107; C09J 4/00; C09J 153/00; B33Y 70/00

(52) U.S. Cl. CPC C08F 290/048; C09D 4/00; C09D 153/00; C09D 11/101; B33Y 80/00; C09J 4/00; C09J 153/00; B33Y 70/00; C08F 2438/02; C09D 11/107

(57) ABSTRACT

Provided is a polymerizable composition including a mixture of at least one monomer which is capable of undergoing radical polymerization and which bears at least one polymerizable function, of at least one flexible dormant polymer block capable of generating at least one radical, and at least one free-radical generator derived from the decomposition of a photoinitiator. The composition may be used as a component of an adhesive, coextrusion binder, varnish, coating, resin for impregnating fabrics or woven materials, a composition suitable for printing on a flexible support or a composition suitable for 3D printing, for example.

The present invention relates to a low-viscosity polymerizable composition which is a precursor of impact-strengthened materials.

Such a composition is useful in fields such as adhesives, varnishes and coatings, resins for impregnating fabrics or woven materials, in the coating of flexible supports or in 3D printing processes.

The composition may be polymerized by means of a photoinitiator under the influence of an electromagnetic radiation (gamma, UV, visible or infrared rays) originating from a source such as a lamp that is capable of generating such radiation (lasers, plasma arc lamps, xenon lamps, mercury lamps, halogen lamps or light-emitting diode lamps). In addition, as regards 3D printing applications, a multi-photon-emitting source may be used.

According to an alternative to the invention, the composition may also be polymerized using a radical initiator.

In these technical fields, compositions that have good mechanical properties on conclusion of polymerization and that have a low viscosity on application, i.e. before polymerization, are sought.

It is known practice to reinforce such compositions with core-shell particles. However, such polymerized compositions have insufficient impact strength and resistance to crack propagation when compositions with low viscosities typically below 10 Pa·s are sought. Moreover, this approach requires these particles to be prepared separately, which complicates the manufacture of these compositions.

Another improved approach consists in reinforcing such polymerized compositions using block copolymers. Such an approach is described, for example, in WO 2008/110 564 or WO 2007/124 911.

However, the incorporation of an impact modifier, whether of the core-shell or block copolymer type, besides the obligation of preparing it separately, entails an increase in the viscosity of the composition, which may pose working problems in the various fields concerned by the invention, for example the impregnation of woven fibers or in the field of 3D printing. Specifically, in the latter case, it has been noted that it was preferable for a composition to have rheological behavior of Newtonian type rather than pseudo-plastic type, to avoid turbulence and thus to maintain laminar flow profiles.

The Applicant has observed that the incorporation of reactive flexible polymer blocks in “dormant” form giving the polymerized composition mechanical strength properties is possible and can advantageously overcome the drawbacks observed in the prior art.

### SUMMARY OF THE INVENTION

The invention relates to a polymerizable composition comprising a mixture of at least one monomer which is capable of undergoing radical polymerization and which bears at least one polymerizable function, of at least one flexible dormant polymer block capable of generating at least one radical, and at least one free-radical generator.

### DETAILED DESCRIPTION

As regards the monomers that are capable of undergoing radical polymerization, they may be multifunctional or non-multifunctional monomers chosen from vinyl, vinylidene, diene, olefin, allylic and (meth)acrylic monomers chosen more particularly from vinylaromatic monomers such as styrene or substituted styrenes, especially α-methylstyrene, silyl styrenes, acrylic monomers such as acrylic acid or salts thereof, alkyl, cycloalkyl or aryl acrylates such as methyl, ethyl, butyl, ethylhexyl, phenyl or isobornyl acrylate, hydroxyalkyl acrylates such as 2-hydroxyethyl acrylate, alkyl ether acrylates such as 2-methoxyethyl acrylate, alkoxy- or aryloxy-polyalkylene glycol acrylates such as methoxypolyethylene glycol acrylates, ethoxypolyethylene glycol acrylates, methoxypolypropylene glycol acrylates, methoxypolyethylene glycol-polypropylene glycol acrylates, or mixtures thereof, aminoalkyl acrylates such as 2-(dimethylamino)ethyl acrylate (DMAEA), fluoro acrylates, silyl acrylates, phosphorus acrylates such as alkylene glycol phosphate acrylates, glycidyl or dicyclopentenyloxyethyl acrylates, methacrylic monomers such as methacrylic acid or salts thereof, alkyl, cycloalkyl, alkenyl or aryl methacrylates such as methyl methacrylate (MMA), lauryl, cyclohexyl, allyl, phenyl, naphthyl or isobornyl methacrylate, hydroxyalkyl methacrylates such as 2-hydroxyethyl methacrylate or 2-hydroxypropyl methacrylate, alkyl ether methacrylates such as 2-ethoxyethyl methacrylate, alkoxy- or aryloxy-polyalkylene glycol methacrylates such as methoxypolyethylene glycol methacrylates, ethoxypolyethylene glycol methacrylates, methoxypolypropylene glycol methacrylates, methoxy-polyethylene glycol-polypropylene glycol methacrylates, or mixtures thereof, aminoalkyl methacrylates such as 2-(dimethylamino)ethyl methacrylate (DMAEMA), fluoro methacrylates such as 2,2,2-trifluoroethyl methacrylate, silyl methacrylates such as 3-methacryloylpropyl-trimethylsilane, phosphorus methacrylates such as alkylene glycol phosphate methacrylates, hydroxyethylimidazolidone methacrylate, hydroxyethylimidazolidinone methacrylate, 2-(2-oxo-1-imidazolidinyl)ethyl methacrylate, acrylonitrile, acrylamide or substituted acrylamides, 4-acryloylmorpholine, N-methylolacrylamide, methacrylamide or substituted methacrylamides, N-methylolmethacrylamide, methacrylamidopropyltrimethylammonium chloride (MAPTAC), glycidyl or dicyclopentenyloxyethyl methacrylates, itaconic acid, maleic acid or salts thereof, maleic anhydride, alkyl or alkoxy- or aryloxy-polyalkylene glycol maleates or hemimaleates, polyol polyacrylates, alkylene glycol polyacrylates or allyl acrylate, ethylene glycol diacrylate, 1,3-butylene glycol diacrylate or 1,4-butylene glycol diacrylate, polyfunctional methacrylic monomers such as polyol polymethacrylates, alkylene glycol polymethacrylates or allyl methacrylate, ethylene glycol dimethacrylate, 1,3-butylene glycol dimethacrylate or 1,4-butylene glycol dimethacrylate, divinylbenzene or trivinylbenzene, vinylpyridine, vinylpyrrolidinone, (alkoxy) poly(alkylene glycol) vinyl ether or divinyl ether, such as methoxy poly(ethylene glycol) vinyl ether, poly(ethylene glycol) divinyl ether, olefinic monomers, among which mention may be made of ethylene, butene, hexene and 1-octene, 1,1-diphenylethylene, diene monomers including butadiene, isoprene and also fluoro olefinic monomers, and vinylidene monomers, among which mention may be made of vinylidene fluoride, alone or as a mixture.

As regards the monomers that are capable of undergoing radical polymerization, they may also be polymer or oligomer blocks that are capable of undergoing radical polymerization in addition to one or more monomers listed previously. The term “polymer or oligomer blocks that are capable of undergoing radical polymerization” means polymer or oligomer blocks with any Tg (glass transition temperature) measured by DSC (differential thermal analysis), but preferably greater than 0° C. and more preferably greater than 50° C. and bearing at least one double bond.

They may be mono- or multifunctional epoxy acrylates or methacrylates derived from the reaction of acrylic or methacrylic acid with a mono- or polyepoxide compound, urethane acrylates derived from the reaction of a hydroxylated acrylate or methacrylate (such as a hydroxyalkyl acrylate or methacrylate with C2 to C4 alkyl, in particular hydroxyethyl acrylate or methacrylate, HEA or HEMA) with an isocyanate or polyisocyanate, which is preferably aliphatic or cycloaliphatic, mono- or multifunctional acrylate aminoacrylates, derived from the Michael addition of a secondary amine to a multifunctional acrylate and partial saturation by this addition of acrylate functions (with at least one if not several residual acrylate functions per aminoacrylate molecule), (meth)acrylic oligomers chosen from the following groups:
polyether acrylates or methacrylates resulting from the esterification with acrylic or methacrylic acid of a polyether polyol or monool, with an Mn which may range up to 2000 (oligoether based on a C2 to C4 alkoxy unit, in particular polyoxyethylenes or polyoxypropylenes or polyoxybutylene or oxyethylene/oxypropylene/oxybutylene random or block copolyethers). The polyoxyethylene or polyoxypropylene is also referred to as polyethylene glycol or polypropylene glycol;
polyester acrylates or methacrylates derived from esterification with acrylic or methacrylic acid of a polyester polyol or monool. Said polyesters are polycondensation products between a polyacid (diacid) and a polyol (diol) and may be of variable structure depending on the structures of these polyacid and/or polyol components;
polyurethane acrylates or methacrylates which can result from the esterification reaction of a polyurethane polyol or monool (for example of polyester type) with acrylic or methacrylic acid or from the reaction between a polyurethane polyisocyanate prepolymer (oligomer) and a hydroxyalkyl acrylate or methacrylate;
epoxy acrylate oligomers resulting from the acrylation or methacrylation of a monoepoxidized or polyepoxidized oligomer (for example epoxidized oligodienes, such as epoxidized polybutadiene or epoxidized polyunsaturated oils);
acrylate or methacrylate acrylic oligomers such as copolymers of glycidyl methacrylate (GLYMA) with another acrylic or methacrylic comonomer, by reaction with acrylic or methacrylic acid. These blocks have a weight-average molecular mass of between 200 and 10 000 g/mol and preferably between 300 and 2000 g/mol, measured by size exclusion chromatography (polystyrene standards).

As regards the flexible dormant polymer blocks that are capable of generating at least one radical, they have a Tg (glass transition temperature) measured by DSC (differential thermal analysis) of less than 0° C. and preferably less than −20° C.

They consist of monomers as listed in the monomers that are capable of undergoing radical polymerization and have a weight-average molecular mass of between 5000 and 1 000 000 g/mol, preferably between 50 000 and 400 000 g/mol, more preferably between 50 000 and 300 000 g/mol, and more particularly between 50 000 and 200 000 g/mol, measured by SEC (size exclusion chromatography, polystyrene standards). Preferably, the flexible blocks comprise butyl acrylate.

The flexible blocks are present in the composition in mass proportions of between 0.1% and 50%, preferably between 0.1% and 30%, more preferentially between 0.1% and 15%, more preferably between 0.1% and 7%, more particularly between 0.1% and 5% and ideally between 2% and 5%. A singular point at which the impact strength passes through a maximum is revealed at 3.5%.

These flexible dormant polymer blocks are prepared by controlled radical polymerization such as NMP (nitroxide-mediated polymerization), RAFT (reversible addition and fragmentation transfer), ATRP (atom-transfer radical polymerization), INIFERTER (initiator-transfer-termination), RITP (reverse iodine transfer polymerization) or ITP (iodine transfer polymerization). The notion of a “dormant” block or dormant chain is explained, for example, in the publication “The chemistry of radical polymerization” by Graeme Moad and David H. Solomon, Elsevier 2006, page 456. They are in particular capable of generating at least one radical which can then initiate a polymerization on said block.

According to a preferred form of the invention, the flexible dormant polymer blocks are prepared by controlled radical polymerization with nitroxides, and more particularly nitroxides obtained from alkoxyamines derived from the stable free radical (1). In this case, the flexible dormant polymer blocks are thus alkoxyamines:

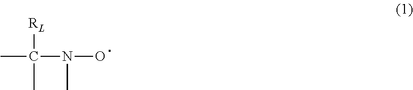

in which the radical R_{L} has a molar mass of greater than 15.0342 g/mol. The radical R_{L} may be a halogen atom such as chlorine, bromine or iodine, a saturated or unsaturated, linear, branched or cyclic, hydrocarbon-based group, such as an alkyl or phenyl radical, or an ester group —COOR or an alkoxyl group —OR or a phosphonate group —PO(OR)₂, as long as it has a molar mass greater than 15.0342. The monovalent radical R_{L}> is said to be in the β position relative to the nitrogen atom of the nitroxide radical. The remaining valencies of the carbon atom and of the nitrogen atom in formula (1) can be bonded to various radicals, such as a hydrogen atom or a hydrocarbon-based radical, for instance an alkyl, aryl or arylalkyl radical, comprising from 1 to 10 carbon atoms. It is not excluded for the carbon atom and the nitrogen atom in formula (1) to be connected together via a divalent radical, so as to form a ring. Preferably, however, the remaining valences of the carbon atom and of the nitrogen atom of formula (1) are bonded to monovalent radicals. Preferably, the radical R_{L} has a molar mass of greater than 30 g/mol. The radical R_{L} may, for example, have a molar mass of between 40 and 450 g/mol. By way of example, the radical R_{L} may be a radical comprising a phosphoryl group, it being possible for said radical R_{L} to be represented by the formula:

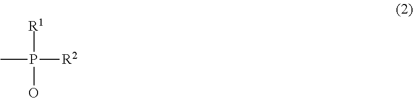

in which R¹ and R², which may be identical or different, may be chosen from alkyl, cycloalkyl, alkoxyl, aryloxyl, aryl, aralkyloxyl, perfluoroalkyl and aralkyl radicals, and may comprise from 1 to 20 carbon atoms. R¹ and/or R² may also be a halogen atom such as a chlorine, bromine, fluorine or iodine atom. The radical R_{L} may also comprise at least one aromatic ring, such as for the phenyl radical or the naphthyl radical, it being possible for said ring to be substituted, for example with an alkyl radical comprising from 1 to 4 carbon atoms.

More particularly, the alkoxyamines derived from the following stable radicals are preferred:
N-(tert-butyl)-1-phenyl-2-methylpropyl nitroxide,
N-(tert-butyl)-1-(2-naphthyl)-2-methylpropyl nitroxide,
N-(tert-butyl)-1-diethylphosphono-2,2-dimethyl propyl nitroxide,
N-(tert-butyl)-1-dibenzylphosphono-2,2-dimethylpropyl nitroxide,
N-phenyl-1-diethylphosphono-2,2-dimethylpropyl nitroxide,
N-phenyl-1-diethylphosphono-1-methylethyl nitroxide,
N-(1-phenyl-2-methylpropyl)-1-diethylphosphono-1-methylethyl nitroxide,
4-oxo-2,2,6,6-tetramethyl-1-piperidinyloxy nitroxide,
2,4,6-tri-tert-butylphenoxy nitroxide.

The alkoxyamines used in controlled radical polymerization must allow good control of the linking of the monomers. Thus, they do not all allow good control of certain monomers. For example, the alkoxyamines derived from TEMPO make it possible to control only a limited number of monomers; the same is true for the alkoxyamines derived from 2,2,5-trimethyl-4-phenyl-3-azahexane 3-nitroxide (TIPNO). On the other hand, other nitroxide-based alkoxyamines corresponding to formula (1), particularly those derived from the nitroxides corresponding to formula (2) and even more particularly those derived from N-tert-butyl-1-diethylphosphono-2,2-dimethylpropyl nitroxide make it possible to broaden to a large number of monomers the controlled radical polymerization of these monomers.

The flexible dormant polymer blocks are thus polyalkoxyamines and may be represented by the formula Z(-T)ₙ in which Z denotes the flexible segment, T a nitroxide and n an integer greater than or equal to 1 and preferably between 2 and 4, limits included. According to a more preferred form, n is equal to 3.

Such flexible dormant polyalkoxyamine blocks may be prepared by reacting the monomers of the flexible block with precursors which are themselves polyalkoxyamines and described in EP 1 526 138.

The polymerization reaction of the composition is initiated using a free radical derived from the decomposition of an initiator or a photoinitiator.

According to a first preference, it is a radical derived from the decomposition of a radical initiator either by temperature or by a redox reaction, or another redox system that can generate radicals, for instance the methylenebis(diethyl malonate)-cerium(IV) couple, or alternatively the H₂O₂/Fe²⁺ couple.

As regards the radical initiator, it may be chosen from diacyl peroxides, peroxy esters, dialkyl peroxides, peroxyacetals and azo compounds. Radical initiators that may be suitable for use are, for example, isopropyl carbonate, benzoyl, lauroyl, caproyl or dicumyl peroxide, tert-butyl perbenzoate, tert-butyl 2-ethylperhexanoate, cumyl hydroperoxide, 1,1-di(tert-butylperoxy)-3,3,5-trimethylcyclohexane, tert-butyl peroxyisobutyrate, tert-butyl peracetate, tert-butyl perpivalate, amyl perpivalate and tert-butyl peroctoate. It would not constitute a departure from the scope of the invention to use a mixture of radical initiators chosen from the above list. The preferred radical initiator is a peroxide, and more particularly benzoyl peroxide.

According to one variant, the radical is generated by reaction between a peroxide and an amine.

As regards the amine, any type of amine that is capable of reacting with a peroxide may be used.

Preferably, they are substituted amines, and more particularly trisubstituted amines, among which mention may be made of N,N-dimethylaniline (DMA) and para-substituted derivatives thereof such as dimethyl-p-toluidine (DMPT), p-hydroxymethyl-N,N-dimethylaniline (NMDA), p-nitro-N,N—N,N-dimethylaniline (NDMA) and p-dimethylaminobenzaldehyde (DMAB). More particularly, the amine is dimethyl-p-toluidine.

According to a second preference, which is the preference of the invention, the radical is derived from the decomposition of a photoinitiator.

Photoinitiators are compounds that are capable of generating free radicals when these compounds are exposed to an electromagnetic radiation. Preferably, the electromagnetic radiations have wavelengths in the ultraviolet or visible range, but it would not constitute a departure from the context of the invention to use wavelengths in shorter wavelength ranges (x-rays or gamma rays) or longer wavelength ranges (infrared or even above).

It may also be a photoinitiator that is capable of generating free radicals by absorption of at least two photons.

The latter example is particularly useful when it is a matter of selectively polymerizing a zone in the mass of the reaction mixture, in particular in the field of 3D printing involving polymerization in the presence of a photoinitiator, i.e. the creation of three-dimensional objects and of prototypes by polymerization of successive layers using a laser beam.

The photoinitiators may be of any type. Preferably, they are chosen from those which generate free radicals by a homolytic cleavage reaction in the α position relative to the carbonyl group, such as benzoin ether derivatives, hydroxyalkylphenones, dialkoxyacetophenones, and also acylphosphine oxide derivatives, and in the β position such as ketone sulfides and sulfonyl ketone derivatives, and those which form free radicals by abstracting hydrogen from a hydrogen donor, such as benzophenones or thioxanthones. The process involves a charge-transfer complex with an amine, followed by an electron and proton transfer leading to the formation of an initiating alkyl radical and an inactive ketyl radical. Mention may be made of benzyl diacetals, hydroxyalkylphenones α-amino ketones, acylphosphine oxides, benzophenones and thioxanthones. It would not constitute a departure from the context of the invention to use a combination of several photoinitiators, or alternatively a combination of photoinitiators and of radical initiator(s), the radicals of which are generated thermally or by redox reaction, for example the methylenebis(diethyl malonate)-cerium(IV) couple or alternatively the H₂O₂/Fe²⁺ couple.

Among the initiators combined with the photoinitiators, mention may be made of diacyl peroxides, peroxy esters, dialkyl peroxides, peroxyacetals and azo compounds. Radical initiators that may be suitable for use are, for example, isopropyl carbonate, benzoyl, lauroyl, caproyl or dicumyl peroxide, tert-butyl perbenzoate, tert-butyl 2-ethylperhexanoate, cumyl hydroperoxide, 1,1-di(tert-butylperoxy)-3,3,5-trimethylcyclohexane, tert-butyl peroxyisobutyrate, tert-butyl peracetate, tert-butyl perpivalate, amyl perpivalate and tert-butyl peroctoate.

The compositions of the invention may also comprise various additives, such as plasticizers, heat or UV stabilizers, mercaptans, sulfites, bisulfites, thiosulfites, hydroxylamines, amines, hydrazine (N₂H₄), phenylhydrazine (PhNHNH₂), hydrazones, hydroquinone, flavonoids, β-carotene, vitamin A, α-tocopherols, vitamin E, propyl or octyl gallate, BHT, propionic acid, ascorbic acid, sorbates, reducing sugars, sugars comprising aldehydes, glucose, lactose, fructose, dextrose, potassium tartrate, nitrites, dextrin, aldehydes, glycine, antioxidants, colorants, fillers or short or long organic or mineral fibers, depending on the final use of the object obtained by the use of the composition of the invention.

The compositions of the invention may thus be used preferentially in 3D printing processes such as stereo-lithography (SLA), “digital light processing” (DLP), the “polyjet” technology and 2PP (2-photon polymerization).

The compositions of the invention may also be used in the field of adhesives, coextrusion binders, varnishes and coatings, resins for impregnating fabrics or woven materials, of short or long fibers whether they are mineral or non-mineral, and printing on a flexible support (paper, polymer, metal).

The compositions may be used in a temperature range between −50 and +150° C., preferably between −20 and +80° C. and more preferably between 5 and 50° C.

They have a viscosity at room temperature (typically 20° C.) of less than 10 Pa·s, preferably less than 5 Pa·s, more preferably less than 2 Pa·s and more preferentially less than 1 Pa·s and also Newtonian rheological behavior.

The invention also relates to compositions polymerized in the form of objects and also to the objects thus obtained.

### Example 1: Synthesis of a Trifunctional Polyalkoxyamine Flexible Dormant Polybutyl Acrylate Block (PBuA)

The following are introduced into a 1-liter glass reactor equipped with an impeller stirrer and a jacket for heating by circulation of oil:
26 g of pentaerythrityl triacrylate (i.e. 0.0874 mol)
100 g of Blocbuilder® (i.e. 0.2622 mol) (from Arkema)
211 g of ethanol

After introducing the reagents, the reaction mixture is heated (nominal temperature of the oil circulating in the jacket: 90° C.). The temperature of the reaction mixture reaches 80° C. in about 30 minutes.

The reactor temperature is maintained at a stage of 80° C. for 240 minutes.

On conclusion of this step, the resulting reaction mixture is introduced by suction into a jacketed stainless-steel reactor, and the ethanol solvent is then removed by evaporation at 55° C. under reduced pressure for 2 hours.

126 g of a trialkoxylamine are thus recovered; the yield is quantitative.

738.6 g of butyl acrylate and 9.626 g of trialkoxyamine are introduced into a 2-liter metal reactor equipped with an impeller stirrer, a jacket for heating by circulation of oil and a vacuum/nitrogen inlet.

After introducing the reagents, the reaction mixture is degassed via three vacuum/nitrogen flushes. The reactor is then closed and the stirring (100 rpm) and heating (nominal temperature of the oil circulating in the jacket: 125° C.) are started. The temperature of the reaction mixture reaches 113° C. in about 30 minutes. The pressure settles at about 1.5 bar. The reactor temperature is maintained at a stage of 115° C. for 510 minutes. The excess butyl acrylate is then removed by evaporation at 80° C. under reduced pressure over 2 hours.

Analysis by size exclusion chromatography (polystyrene standards) of the trifunctional polyalkoxyamine flexible dormant polybutyl acrylate block (PBuA) gives the following results: Mₙ: 91 000 g/mol; M_{w}: 250 000 g/mol; polydispersity: 2.7

### Example 2: Formulation and Evaluation

Monomers capable of polymerizing:
isobornyl acrylate (SR506D, from Sartomer)
aliphatic polyester urethane diacrylate (CN991—from Sartomer)
tricyclodecanedimethanol diacrylate (SR833S, from Sartomer)
2(2-ethoxyethoxy)ethyl acrylate (SR256—from Sartomer)
polyethylene glycol (200) diacrylate (SR259—from Sartomer)
cyclic trimethylolpropane formal acrylate (SR531—from Sartomer)
lauryl methacrylate (SR313A—from Sartomer)
hydroxypropyl methacrylate (HPMA, from Dow)
methyl methacrylate (MMA—from Arkema)
3,3,5-trimethylcyclohexanol acrylate (SR420—from Sartomer)
polyester acrylate (CN2505—from Sartomer)
urethane acrylate (CN9900—from Sartomer)
α-hydroxyacrylate resulting from the opening of epoxide functions with acrylic acid (CN 104—from Sartomer)
hyperbranched polyester acrylate bearing 16 acrylate functions (CN2305—from Sartomer)
photoinitiator:
ethyl (2,4,6-trimethylbenzoyl)phenyl phosphinate (TPO, photoinitiator, from Lambson)

Reference Block Copolymers (Comparative Tests):

These block copolymers are prepared according to the protocol described in EP 1 526 138, but are also commercially available (Nanostrength® M52N and D51N, from Arkema).

The first block copolymer (BCP 2, M52N) is a polymethyl methacrylate-polybutyl acrylate-polymethyl methacrylate (PMMA-PBuA-PMMA) copolymer with a weight-average molecular mass of 140 kg/mol measured by SEC (polystyrene standards).

The second block copolymer (BCP 1, D51N) is a polymethyl methacrylate-polybutyl acrylate (PMMA-PBuA) copolymer with a weight-average molecular mass of 62 kg/mol measured by SEC (polystyrene standards).

The monomers that are capable of polymerizing are mixed in subdued light either with PBuA or with the block copolymer together until dissolved, and the photoinitiator is then added. The resulting mixture is then poured into a mold consisting of two glass mirrors separated by a PVC seal which is then subjected to irradiation in a UV oven (Delolux 03S mercury UV lamp) for 60 seconds. Type 1 specimens according to standard NF EN ISO 179-1 (February 2001) are manufactured by cutting after removing the polymerized composition from the mold:

Bar length: 80 mm

Width: 10 mm

Thickness: 4 mm

Distance between supports during the measurement: 62 mm

Table 1 collates the various types of compositions used in the context of the invention and outside the invention (comparative tests): the values of the constituents are given as mass percentages, along with the measured values of their viscosity, rheological behavior and impact strength after polymerization:

TABLE 1

| | | | | | | | | Viscosity | | |
|---|---|---|---|---|---|---|---|---|---|---|
| | | | | | | | | at 23° C. | Rheological | Impact |
| | SR506D | CN991 | SR833S | TPO | PBuA | BCP2 | BCP1 | (mPa · s) | behavior | (kJ/m²) |
| control | 40 | 32.0 | 27.0 | 1 | | | | 0.2 | Newtonian | 10.1 |
| test 1 (invention) | 38.6 | 30.9 | 26.1 | 0.965 | 3.5 | | | 0.4 | Newtonian | 30.5 |
| test 2 (invention) | 37.2 | 29.8 | 25.1 | 0.93 | 7 | | | 0.85 | Newtonian | 15.7 |
| test 3 (invention) | 34 | 27.2 | 23.0 | 0.85 | 15 | | | 2.4 | Newtonian | 10.6 |
| test 4 (comparative) | 37.2 | 29.8 | 25.1 | 0.93 | | 3.5 | | 0.7 | Newtonian | 23.3 |
| test 5 (comparative) | 34 | 27.2 | 23.0 | 0.85 | | 7 | | 1.86 | Newtonian | 22 |
| test 6 (comparative) | 38.6 | 30.9 | 26.1 | 0.965 | | 15 | | 15.4 | Pseudo-plastic | 20.4 |
| test 7 (comparative) | 37.2 | 29.8 | 25.1 | 0.93 | | | 7 | 1.08 | Newtonian | 15.6 |
| test 8 (comparative) | 34 | 27.2 | 23.0 | 0.85 | | | 15 | 6.8 | Pseudo-plastic | 18.8 |

The impact strength is measured according to standard NF EN ISO 179-1 (February 2001); non-notched Charpy impact.

The viscosity of the formulations is determined on an MCR301 imposed-stress rheometer from Anton Paar.

The measurement is performed by flow stress sweep at 20° C. The geometry used is of Couette type for which the temperature regulation is provided by the Peltier effect. The Couette geometry used is given in FIG. 1.

The formulation without photoinitiator is introduced into the Couette geometry gap using a disposable pipette. The shear gradient range varies logarithmically from 0.1 to 1000 s⁻¹ with measurement of 10 points per period of 10 days.

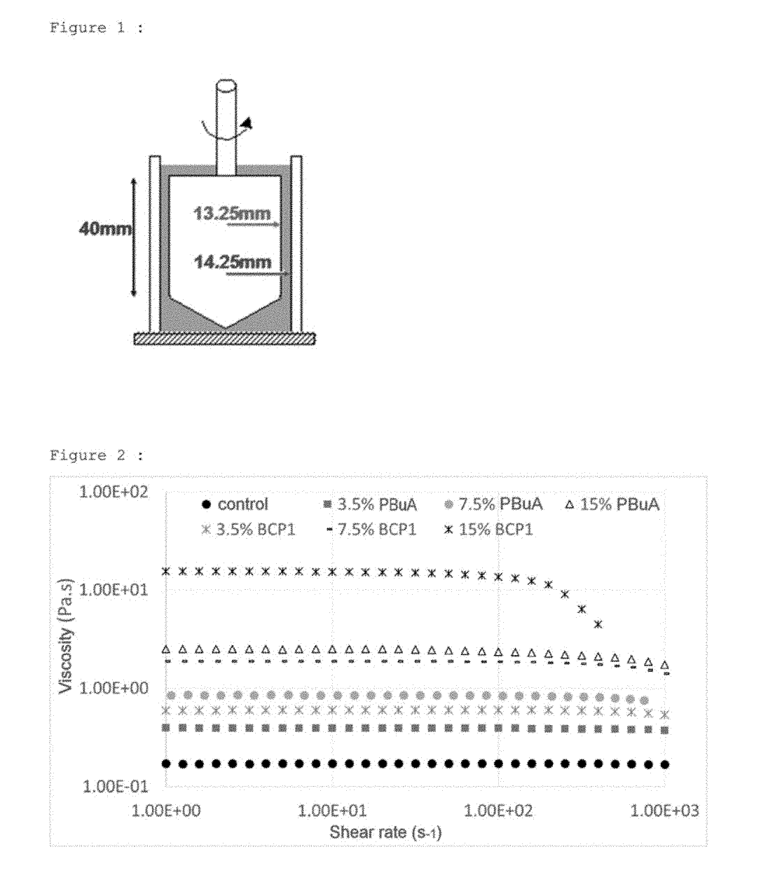

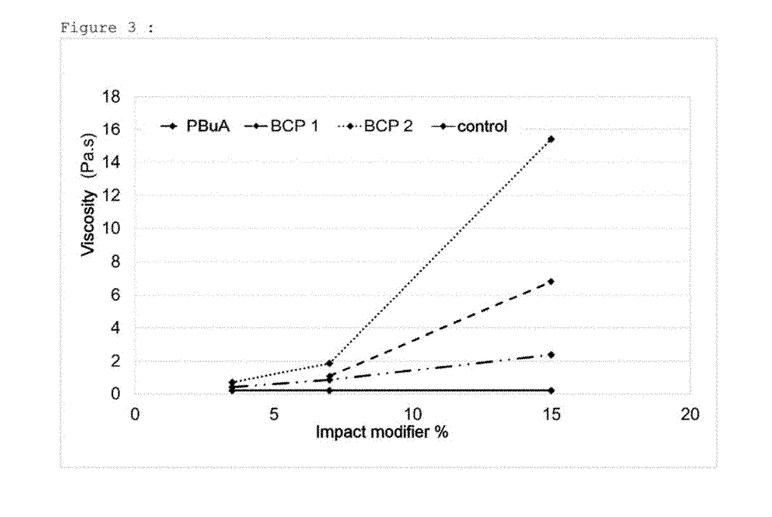

The curve of product flow viscosity as a function of the shear gradient may then be obtained (FIG. 2).

From these measurements, it is found that the formulations of the invention all have Newtonian behavior. Moreover, the viscosity values obtained with the formulations of the invention are much lower than with the comparative formulations even with a molecular mass of the flexible block higher than those of the block copolymers used in the comparatives (FIG. 3).

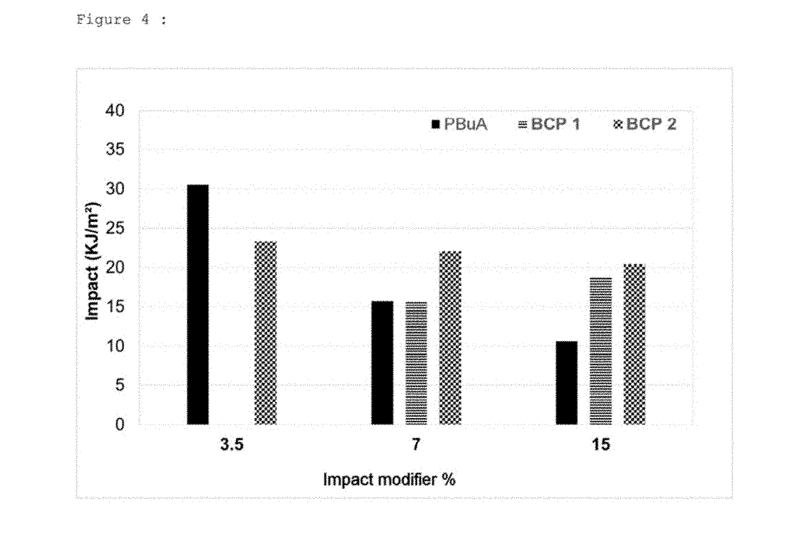

Finally, the impact strength is, surprisingly, much better for the compositions of the invention at low contents (3.5% in the example), FIG. 4.

By more finely studying the influence of the content of PBuA in formulations similar to those of table 1, the existence of a singular point may be revealed:

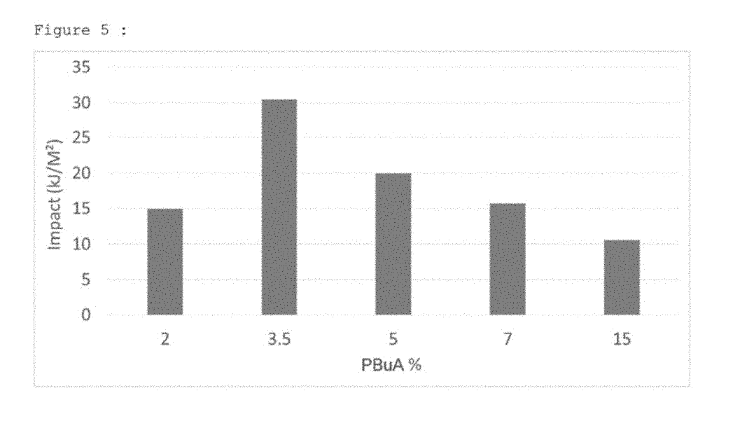

TABLE 1
bis and FIG. 5:

| PBuA % | Impact (kJ/m²) |
|---|---|
| 2 | 15 |
| 3.5 | 30.5 |
| 5 | 20 |
| 7 | 15.7 |
| 15 | 10.6 |

### Example 3: Formulation and Evaluation

Tables 2 and 3 collate the various types of compositions used in the context of the invention and outside the invention (control comparative tests): the values of the constituents are given as parts by mass, along with the measured values of their viscosity, and impact strength after polymerization:

TABLE 2

| | | | | | | | | | | | | | Viscosity | |
|---|---|---|---|---|---|---|---|---|---|---|---|---|---|---|
| | CN9900 | MMA | SR506D | SR833S | SR256 | SR259 | SR531 | SR313 | HPMA | SR420 | | PBuA | at 23° C. | Impact |
| | (g) | (g) | (g) | (g) | (g) | (g) | (g) | (g) | (g) | (g) | TPO | (g) | (mPa · s) | (kJ/m²) |
| Test 9 - | 18 | 7 | 75 | 7 | | | | | | | 1 | | 13 | 9 |
| Control | | | | | | | | | | | | | | |
| Test 11 | 18 | 7 | 75 | 7 | | | | | | | 1 | 3 | 34 | 17 |
| Test 12 | 18 | 7 | 75 | 7 | | | | | | | 0.5 | 3 | 33 | 19 |
| Test 13 - | 18 | 7 | 65 | 7 | 10 | | | | | | 1 | | 12 | 8 |
| Control | | | | | | | | | | | | | | |
| Test 14 | 18 | 7 | 65 | 7 | 10 | | | | | | 1 | 3 | 29 | 34 |
| Test 15 - | 18 | 7 | 65 | 7 | | 10 | | | | | 1 | | 11 | 13 |
| Control | | | | | | | | | | | | | | |
| Test 16 | 18 | 7 | 65 | 7 | | 10 | | | | | 1 | 3 | 31 | 27 |
| Test 17 - | 18 | 7 | 65 | 7 | | | 10 | | | | 1 | | 15 | 9 |
| Control | | | | | | | | | | | | | | |
| Test 18 | 18 | 7 | 65 | 7 | | | 10 | | | | 1 | 3 | 37 | 15 |
| Test 19 - | 18 | 7 | 65 | | | | | 7 | 10 | | 1 | | 11 | 7 |
| Control | | | | | | | | | | | | | | |
| Test 20 | 18 | 7 | 65 | | | | | 7 | 10 | | 1 | 3 | 25 | 16 |
| Test 21 - | 18 | 7 | | | | | | | | 75 | 1 | | 9 | 14 |
| Control | | | | | | | | | | | | | | |
| Test 22 | 18 | 7 | | | | | | | | 75 | 1 | 3 | 26 | 40 |

TABLE 3

| | | | | | | | | | | Viscosity | |
|---|---|---|---|---|---|---|---|---|---|---|---|
| | CN104 | CN2305 | CN2505 | MAM | SR506D | SR835 | SR526 | | PBuA | at 23° C. | Impact |
| | (g) | (g) | (g) | (g) | (g) | (g) | (g) | TPO | (g) | (mPa · s) | (kJ/m²) |
| Test 23- | 18 | | | 7 | 65 | 7 | 10 | 1 | | 25 | 8 |
| Control | | | | | | | | | | | |
| Test 24 | 18 | | | 7 | 65 | 7 | 10 | 1 | 3 | 55 | 13 |
| Test 25- | | 18 | | 7 | 65 | 7 | 10 | 1 | | 7 | 8 |
| Control | | | | | | | | | | | |
| Test 26 | | 18 | | 7 | 65 | 7 | 10 | 1 | 3 | 19 | 17 |
| Test 27- | | | 18 | 7 | 65 | 7 | 10 | 1 | | 10 | 7 |
| Control | | | | | | | | | | | |
| Test 28 | | | 18 | 7 | 65 | 7 | 10 | 1 | 3 | 26 | 25 |

From these measurements, it is found that the formulations of the invention all have a low viscosity, but all show an increase in impact strength when compared with the references, in the presence of a wide variety of monomers: polar monomers (SR 256, SR 259 or SR 531—Tests 13 to 18) or apolar monomers (SR 313—Tests 19 and 20), acrylate or methacrylate monomers (SR 313 and HPMA—Tests 19 and 20), monomers with high functionality (CN2305, hyperbranched acrylate—Tests 25 and 26) or monomers with low functionality (SR 420, monofunctional acrylates—Tests 25 to 28), and also in the presence of varied chemical functions such as hydroxyls (HPMA—Tests 19 and 20 or CN104—Tests 23 and 24), urethane functions (CN9900) or simple esters (CN2505—Tests 27 and 28).

The effect is also observed in the presence of a variable amount of photoinitiator (Tests 9-12).

1. A polymerizable composition comprising a mixture of at least one monomer which is capable of undergoing radical polymerization and which bears at least one polymerizable function, of at least one flexible dormant polymer block capable of generating at least one radical, and at least one free-radical generator derived from the decomposition of a photoinitiator.

2. The composition as claimed in claim 1, in which at least one flexible dormant polymer block is a polyalkoxyamine represented by the formula Z(-T)ₙ in which Z denotes the flexible segment, T a nitroxide and n an integer greater than or equal to 1.

3. The composition as claimed in claim 2, in which the nitroxide is N-(1-phenyl-2-methylpropyl)-1-diethylphosphono-1-methylethyl nitroxide.

4. The composition as claimed in claim 1, in which at least one monomer that is capable of undergoing radical polymerization is a multifunctional or non-multifunctional acrylate or methacrylate.

5. The composition as claimed in claim 2, in which Z is a block whose Tg is less than 0° C.

6. The composition as claimed in claim 5, wherein Z is a block comprising butyl acrylate.

7. The composition as claimed in claim 1, comprising at least one functional polymer block that is capable of undergoing radical polymerization of the aliphatic polyester diacrylate or polyurethane diacrylate type.

8. The composition as claimed in claim 1, in which the free-radical generator is obtained from the decomposition of an initiator.

9. The composition as claimed in claim 1, with a viscosity at room temperature of less than 10 Pa·s at 20° C.

10-11: (canceled)

12. The composition as claimed in claim 1, which has a viscosity at room temperature (20° C.) of less than 10 Pa·s and has Newtonian rheological behavior.

13. The composition as claimed in claim 1, which has a viscosity at room temperature (20° C.) of less than 1 Pa·s and has Newtonian rheological behavior.

14. The composition as claimed in claim 1, which has Newtonian rheological behavior.

15. A method of preparing the composition as claimed in claim 1, comprising combining the monomer and the free-radical generator.

16. A method of printing on a flexible support, comprising applying the composition as claimed in claim 1 to a flexible support.

17. The method as claimed in claim 16, wherein the flexible support is paper, polymer, or metal.

18. An adhesive, coextrusion binder, varnish, coating, resin for impregnating fabrics or woven materials, a composition suitable for printing on a flexible support or a composition suitable for 3D printing, comprising the composition as claimed in claim 1.

19. A composition obtained by polymerizing the composition as claimed in claim 1.

20. A 3-D printed object obtained by 3-D printing the composition as claimed in claim 1.
